(19) United States
(12) Patent Application Publication
(10) Pub. No.: US 2002/0117036 A1
(43) Pub. Date: Aug. 29, 2002

(54) Quick clamping vice structure for circular saw

(76) Inventor: Mei-Tung Chen, Taipei (TW)

Correspondence Address: Dougherty & Troxell, ONE SKYLINE PLACE, 5205 LEESBURG PICKE, SUITE 1401, FALLS CHURCH, VA, 22041, US

(21) Appl. No.: 09/794,279

(22) Filed: Feb. 28, 2001

(51) Int. Cl. B26D 7/02

(52) U.S. Cl. 83/457; 83/465; 83/471.2

(57) ABSTRACT

A quick clamping vice structure for a circular saw comprising a vice seat, a fixed seat, a screw rod, a seat member, a base and an electric saw, wherein, the vice seat is disposed in opposition to the fixed seat and is combined with the base, the vice seat is connected with the screw rod, while the screw rod is connected with the seat member, the electric saw is provided on the base, the vice structure is characterized by that: the seat member has a receiving chamber with an elastic member therein to abut against a screw guiding block, and an engaging groove is provided on the lateral wall of the screw guiding block to abut against a shifting rod; by such abutment and by an engaging portion provided on the bottom of the screw guiding block cooperatively arranged with the screw rod in a hole on the seat member, an effect of quick clamping and positioning as well as stable and firm clamping can be obtained.

### BACKGROUND OF THE INVENTION

The present invention is related to a quick clamping vice structure for a circular saw; and especially to a quick clamping vice structure with a design having a screw guiding block, a screw rod and a shifting rod in combination provided in a seat member to make convenience of operation, quick clamping and positioning as well as stable and firm clamping, it is suitable for use on a quick clamping vice structure for a circular saw or the like.

Conventional clamping devices generally are designed to have a working table and a clamp each; the clamp includes a main base, a cooperating clamping member in opposition thereto and a movable clamping block between the two. The main base and the cooperating clamping member are locked respectively on the upper surface of the working table. A screw rod is connected between the main base and the movable clamping block; a rotatable handle is provided to allow the screw rod to push the movable clamping block to fixedly clamp a workpiece placed at the cooperating clamping member between the movable clamping block and the cooperating clamping member, time required for obtaining clamping state is longer. A conventional clamping device is comprised mainly of a vice table, a movable clamping seat, an eccentric wheel set, a swiveling rod and a screw rod etc. By rotating a rotating knob on the screw rod, the screw rod can move an adjustment block along its screw thread, the adjustment block is linked up in motion with the eccentric wheel set provided thereon, and pushes the movable clamping seat by means of the eccentric wheel of the eccentric wheel set and a linking-up rod to render the movable clamping seat to make a long-distance adjustment. When the latter is adjusted to a degree that it can clamp a workpiece, there is still a suitable gap left for free releasing of the workpiece; now the swiveling rod can be moved to make eccentric rotating of the eccentric wheel to have the protruding portion of the eccentric wheel abutted against the movable clamping seat, thereby, the workpiece is tightly clamped in the mouth of the vice. Such eccentric wheel of the eccentric wheel set and the linking-up rod can push the movable clamping seat to accelerate moving of the latter, however, moving speed of the movable clamping seat still is not sufficient; plus that too many members are contained in the structure, this further makes insufficient moving speed of the movable clamping seat and waste of material.

### SUMMARY OF THE INVENTION

The primary object of the present invention is to provide a quick clamping vice structure for a circular saw. By providing an elastic member in a receiving chamber of a seat member to abut against a screw guiding block, and an engaging groove provided on the lateral wall of the screw guiding block to abut against a shifting rod, an engaging portion provided on the bottom of the screw guiding block, a hole provided on the seat member and extending through the receiving chamber for mounting therein a screw rod, and by cooperative arrangement of the engaging portion on the bottom of the screw guiding block with the screw rod, the vice structure can have the effect of convenience of operation, quick clamping and positioning as well as stable and firm clamping.

The secondary object of the present invention is to provide a quick clamping vice structure for a circular saw, by providing a slit on a base, the vice can be moved steadily, an effect of fast as well as steady moving can be obtained, stability thereby can be improved.

To get the objects stated above, the present invention makes combination of the members of a vice seat, a fixed seat, a screw rod, a seat member, a base and a circular saw etc. The vice seat is disposed in opposition to the fixed seat and is combined with the base, the vice seat is connected with the screw rod; while the screw rod is connected with the seat member, the circular saw is provided on the base. An elastic member in a receiving chamber of the seat member is abutted against a screw guiding block; an engaging groove provided on the lateral wall of the screw guiding block abuts against a shifting rod; an engaging portion is provided on the bottom of the screw guiding block; a hole is provided on the seat member and extending through the receiving chamber for mounting therein the screw rod; and the engaging portion on the bottom of the screw guiding block is cooperatively arranged with the screw rod. Thus the vice structure can have the effect of quick clamping and positioning as well as stable and firm clamping, and its practicality and stability can thereby be increased.

The present invention will be apparent in its characteristics and structure after reading the detailed description of the preferred embodiment thereof in reference to the accompanying drawings.

### BRIEF DESCRIPTION OF THE DRAWINGS

FIG. 1 is a perspective view of an embodiment of the present invention;

FIG. 2 is an analytical perspective view of the embodiment of the present invention;

FIG. 3 is a sectional side view of the embodiment of the present invention showing connection and positioning of a screw rod and a seat member;

FIG. 4 is a sectional side view of the present invention showing separation of the screw rod and the seat member;

FIG. 5 is a schematic view showing use of the embodiment of the present invention;

FIG. 6 is a perspective view of another embodiment of the present invention;

FIG. 6a is a sectional side view of the said another embodiment of the present invention showing connection and positioning of a screw rod and a seat member;

FIG. 6b is a sectional side view of the said another embodiment of the present invention showing separation of the screw rod and the seat member.

### DETAILED DESCRIPTION OF THE PREFERRED EMBODIMENT

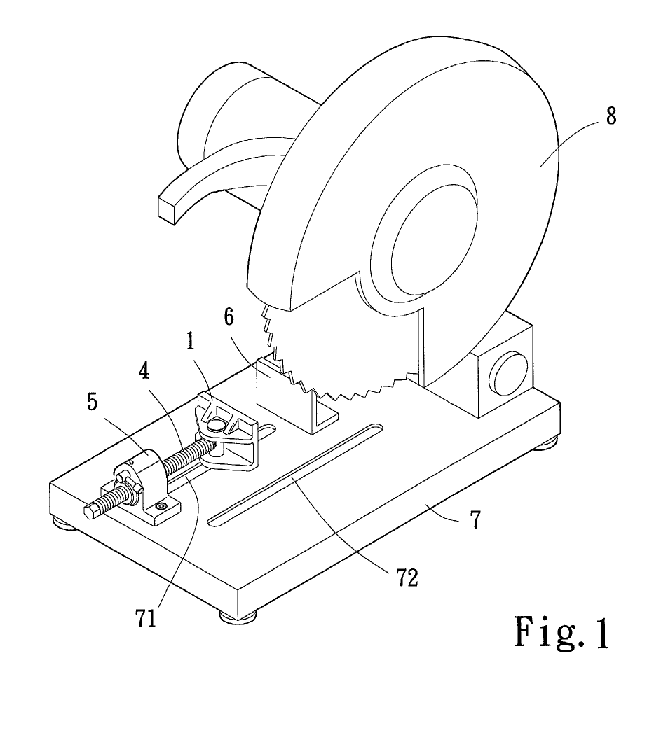

Referring firstly to FIG. 1, 2, the quick clamping vice structure for a circular saw of the present invention is comprised of a vice seat 1, a fixing screw 2, a screw rod 4, a seat member 5, a fixed seat 6, a base 7 and a circular saw 8 etc. The vice seat 1 is provided in the front thereof with a clamping surface 13 of which the rear side has an upper plate portion 11 and a lower plate portion 12 both extending transversely. The upper and the lower plate portions 11, 12 are provided respectively with a hole 111 and 121 for extending therethrough the fixing screw 2.

The fixing screw 2 is provided on the top thereof with a bolt head 21, and on the bottom thereof with a threaded protrusion 23, a through hole 22 is provided on the shank of the fixing screw 2 to be connected with the screw rod 4.

The screw rod 4 is provided with a threaded shank 45, and is provided on one end thereof with an end 41 of smaller diameter. The end 41 is provided on the side wall thereof with a through hole 42, and is slipped thereover by a gasket 3. The end 41 is extended through the through hole 22 provided on the shank of the fixing screw 2, then a pin 44 is inserted into the through hole 42 of the end 41. A rounded portion 441 of the pin 44 is blocked at one end of the through hole 42, while the pin 44 has a pair of feet 442 which are bent after insertion to cling to the wall of the end 41 of the screw rod 4 to render the screw rod 4 to be firmly engaged with the fixing screw 2.

The seat member 5 is in the form of a convex member, and is provided on two lateral wings thereof each with a fixing hole 54 for fixing on the base 7, and is provided therein with a receiving chamber 56 into which a spring 574 and then a screw guiding block 57 are placed from a down-facing opening of the receiving chamber 56. The top of the screw guiding block 57 is provided therein with a recess 571 for bearing the spring 574. The screw guiding block 57 is provided on the wall thereof with an engaging groove 572, and is provided on the bottom thereof with an engaging portion 573. The seat member 5 has a through hole 51 communicating with the receiving chamber 56 for mounting therein the screw rod 4 extending therethrough. The engaging portion 573 on the bottom of the screw guiding block 57 straddles the threaded shank 45 of the screw rod 4. A through hole 52 is provided above the through hole 51 to communicate with the receiving chamber 56 and for inserting therein a shifting rod 58. The shifting rod 58 is provided on the front end thereof with an engaging block 581, and is provided on the wall thereof with an annular engaging groove 582 and a hole 583 to be engaged with an engaging portion 591 with parallel knurled grains. The seat member 5 is provided on the top thereof with a screw hole 53 in communication with the through hole 52, a screw 55 is engaged in the screw hole 53 by means of screw threads and extends into the annular engaging groove 582 of the shifting rod 58 inserted into the through hole 52. Thereby, the shifting rod 58 can only rotate rather than slide leftwards or rightwards.

The base 7 is provided with a slit 71 in cooperating with the fixing screw 2, and is provided with a cutting slit 72. The vice seat 1 and the fixed seat 6 are arranged in opposition with each other, and the vice seat 1 is combined with the base 7 to form the quick clamping vice structure for a circular saw.

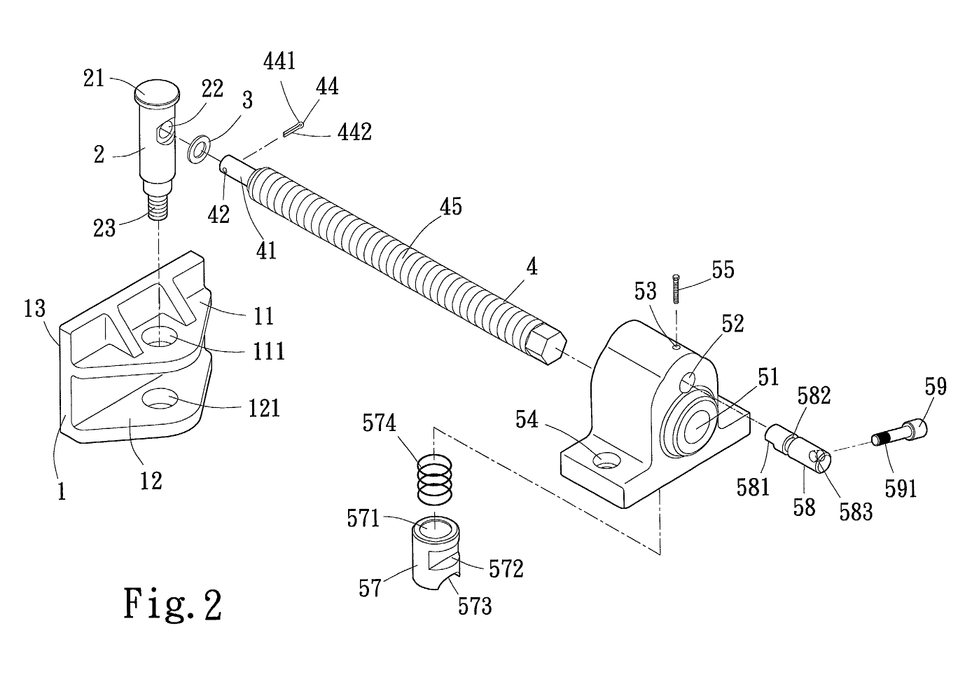

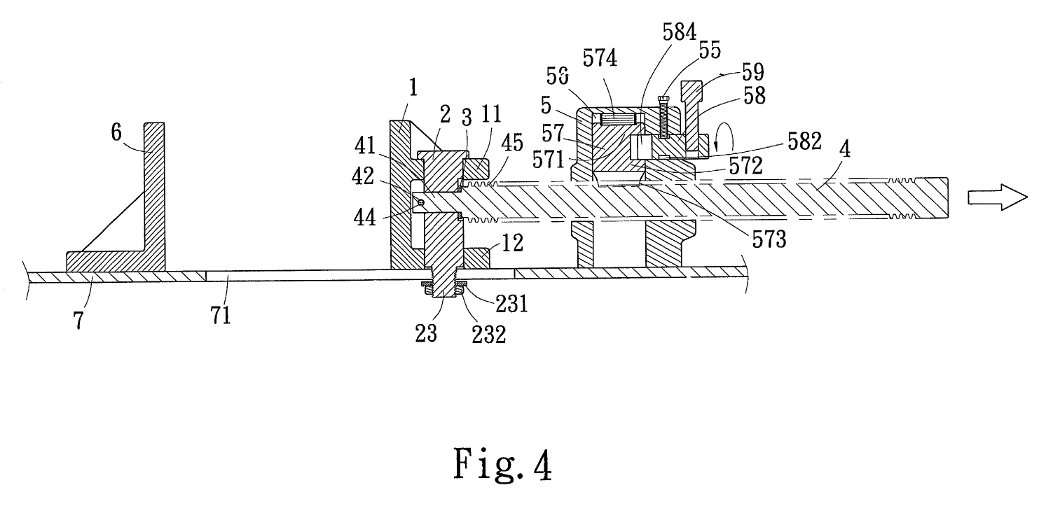

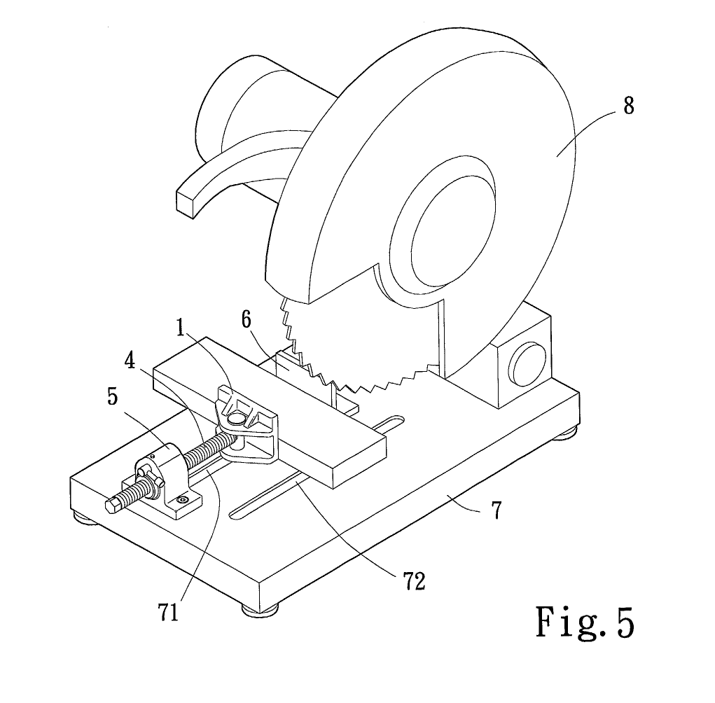

Referring to FIG. 2-5, the present invention is characterized in that, the vice seat 1 and the screw rod 4 are connected with each other by means of the fixing screw 2, the screw rod 4 is extended in the through hole 51 of the seat member 5. With the receiving chamber 56 in the seat member 5 with the opening of the receiving chamber 56 facing downward of the seat member 5, the spring 574 and then the screw guiding block 57 are placed in the receiving chamber 56. The top of the screw guiding block 57 is provided therein with the recess 571 for bearing the spring 574. When the screw rod 4 and the seat member 5 are connected and positioned, the spring 574 pushes the screw guiding block 57 downward, the top surface of the engaging groove 572 on the wall of the screw guiding block 57 is abutted against an abutting surface 584 of the engaging block 581 on the front end of the shifting rod 58, so that the engaging portion 573 on the bottom of the screw guiding block 57 straddles the threaded shank 45 of the screw rod 4. The screw rod 4 and the screw guiding block 57 in the seat member 5 are fixed by engaging in positions; when in clamping an article, it needs only to rotate a grip 59 to simultaneously rotate the shifting rod 58 fixedly connected with the grip 59, the engaging block 581 on the front end of the shifting rod 58 thus is rotated to raise the screw guiding block 57, the spring 574 born in the recess 571 on the top of the screw guiding block 57 is pressed to contract, so that the threaded engaging portion 573 on the bottom of the screw guiding block 57 is raised to be separated from the threaded shank 45 of the screw rod 4; hence the screw rod 4 and the screw guiding block 57 in the seat member 5 are separated from each other. Therefore, the screw rod 4 can fast slide in the through hole 51 of the seat member 5 to fast move the vice seat 1 and the fixing screw 2 in the front of the screw rod 4 to the positions for clamping; now the grip 59 is rotated to make firm engagement in position of the screw rod 4 with the screw guiding block 57 in the seat member 5, thus the vice seat 1 and the fixed seat 6 in opposition thereto can have the function of firm clamping. The threaded protrusion 23 on the bottom of the fixing screw 2 is extended through the slit 71 on the base 7 and is provided thereover with a gasket 231 locked in position by a nut 232. The fixing screw 2 is moved by sliding steadily in the slit 71 of the base 7, thereby, the vice seat 1 moves steadily, and an good quick clamping device is formed. In this way, the present invention can have the effect of convenience of operation, quick clamping and positioning as well as stable and firm clamping, its practicality and convenience are increased and can form a quick clamping vice structure for a circular saw.

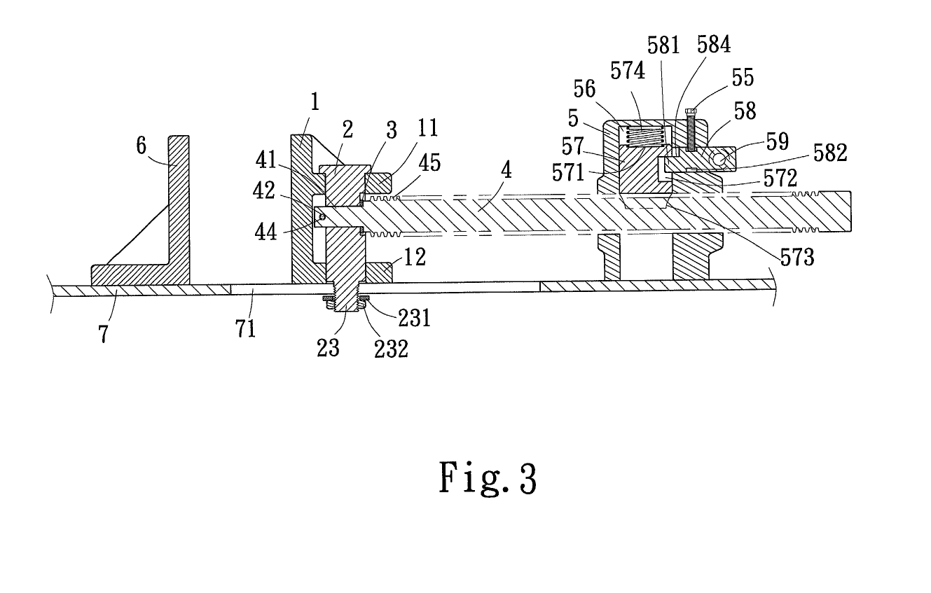

Referring to FIG. 3-5, when the above stated quick clamping vice structure for a circular saw has been assembled, the workpiece to be cut can be placed between the fixed seat 6 and the vice seat 1 on the base 7 and is abutted against the clamping surface of the fixed seat 6. At this time, it needs only to rotate the grip 59 to make separation of the threaded shank 45 of the screw rod 4 from the screw guiding block 57 in the seat member 5; the screw rod 4 can fast slide in the through hole 51 of the seat member 5 to fast move the vice seat 1 and the fixing screw 2 in the front of the screw rod 4 to the positions for clamping; now the grip 59 is rotated to make firm engagement in position of the screw rod 4 with the screw guiding block 57 in the seat member 5, thus the vice seat 1 and the fixed seat 6 in opposition thereto can have the function of firm clamping. In this way, the workpiece to be cut can be clamped quickly, and finally the circular saw 8 is activated to cut the workpiece.

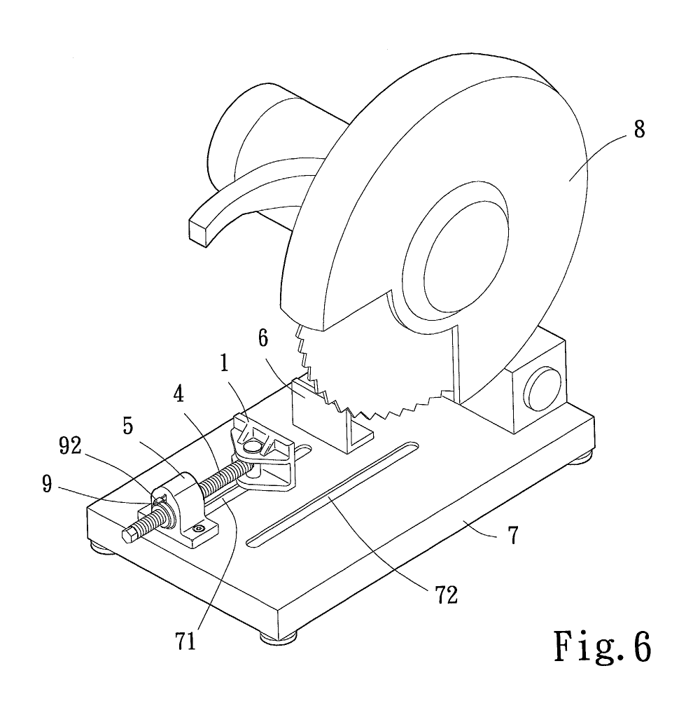

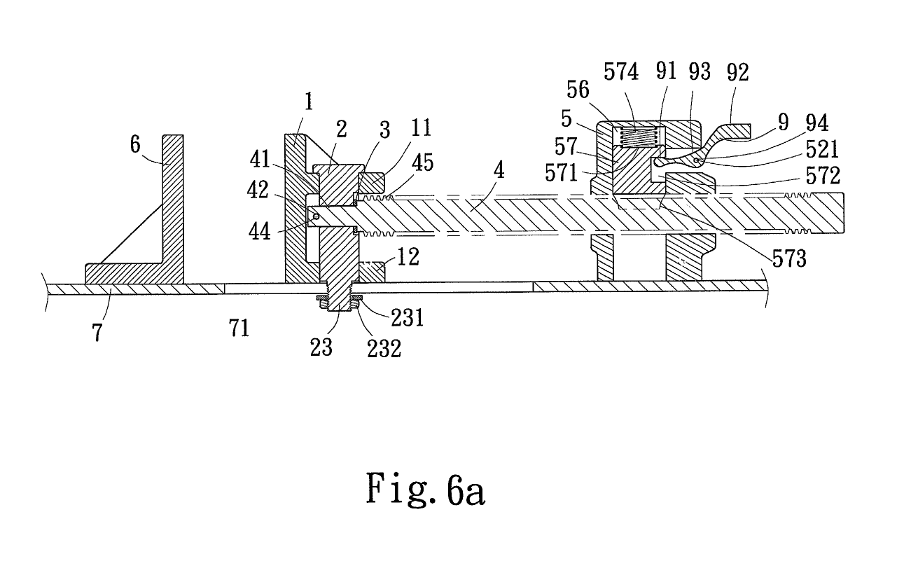

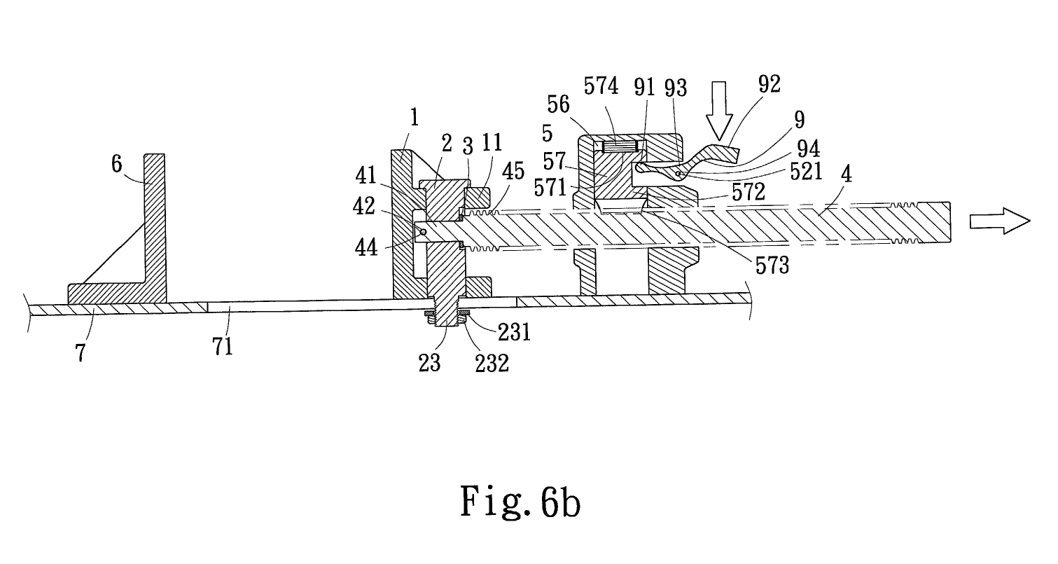

The embodiment of the present invention as shown in FIG. 1-5 is depicted to have a cylindrical shifting rod 58 in combination with a grip 59, by rotating the grip 59, the engaging block 581 on the front end of the shifting rod 58 is rotated to raise the screw guiding block 57; and by moving the screw rod 4, the vice seat 1 connected to the front end of the screw rod 4 can move fast by sliding to the location nearby the workpiece to be cut for clamping the same (referring to FIG. 6-6b). However, a shifting rod 9 with a bending portion 93 can be used instead, the shifting rod 9 is movably and pivotally provided on an engaging axle 521 in the through hole 52 of the seat member 5 by means of a hole 94. The shifting rod 9 is provided on the front end thereof with a protruding engaging block 91, and on the other end thereof with a pressing portion 92. With the design of the engaging axle 521 and the bending portion 93, the protruding engaging block 91 on the front end of the shifting rod 9 is abutted against the upper edge of the engaging groove 572 on the wall of the screw guiding block 57, so that the screw guiding block 57 is raised to compress the spring 574, thus the screw rod 4 can slide fast, and the vice seat 1 on the front end of the screw rod 4 can move fast by sliding to the location nearby the workpiece to be cut. When the pressing portion 92 is released, the compressed spring 574 pushes downward the screw guiding block 57 by its own restoring force, so that the threaded engaging portion 573 on the bottom of the screw guiding block 57 straddles the threaded shank 45 of the screw rod 4. The screw rod 4 and the screw guiding block 57 in the seat member 5 are fixed by engaging in positions, thereby, it needs only that a shifting rod can raise the screw guiding block 57, the objects that the vice seat is fast moved and the workpiece is firmly clamped can be achieved.

Accordingly, the present invention has the following advantages:

1. An elastic member in the receiving chamber of the seat member is abutted against the screw guiding block; the engaging groove provided on the lateral wall of the screw guiding block abuts against the shifting rod; and the engaging portion provided on the bottom of the screw guiding block is cooperatively arranged with the screw rod extending in the hole provided on the seat member. Thus the vice structure can have the effect of quick clamping and positioning as well as stable and firm clamping.

2. In the present invention, by providing a slit on a base to allow a threaded protrusion on the bottom of a fixing screw to slide, the vice seat can thus be moved steadily, an effect of fast as well as steady moving can be obtained.

In conclusion, the present invention not only gets rid of the defects resided in a conventional quick clamping vice structure for a circular saw, but also has an elastic member in the receiving chamber of the seat member abutted against the screw guiding block, and has an engaging groove provided on the lateral wall of the screw guiding block abutted against the shifting rod, and has a design with an engaging portion provided on the bottom of the screw guiding block being cooperatively arranged with the screw rod extending in the hole provided on the seat member, the vice structure can thus have the effect of convenience of operation, quick clamping and positioning as well as stable and firm clamping. Thus practicality and stability of the vice structure can be increased.

Having thus described my invention, what I claim as new and desire to be secured by Letters Patent of the United States are:

1. A quick clamping vice structure for a circular saw comprising a vice seat, a fixed seat, a screw rod, a seat member, a base and an electric saw, wherein: said vice seat is disposed in opposition to said fixed seat and is combined with said base, said vice seat is connected with said screw rod, while said screw rod is connected with said seat member, said vice structure is used to movably clamp firm a workpiece in position, said electric saw is provided on said base, said vice structure is characterized by that:
said seat member has a receiving chamber with an elastic member therein to abut against a screw guiding block, and an engaging groove is provided on the lateral wall of said screw guiding block, an engaging portion is provided on the bottom of said screw guiding block, a hole is provided on said seat member and extending through said receiving chamber for mounting therein said screw rod; and said engaging portion on the bottom of said screw guiding block is cooperatively arranged with said screw rod, a through hole is provided nearby said hole on said seat member and is communicated with said receiving chamber, a shifting rod is provided in said through hole of which the front end is provided with an engaging block which is abutted against said engaging groove on the wall of said screw guiding block, so that said vice structure has an effect of quick clamping and positioning as well as stable and firm clamping.

2. A quick clamping vice structure for a circular saw as in claim 1, wherein, said screw guiding block is provided therein with a recess for bearing said elastic member.

3. A quick clamping vice structure for a circular saw as in claim 1 or 2, wherein, said elastic member is a spring.

4. A quick clamping vice structure for a circular saw as in claim 1, wherein, said engaging portion provided on the bottom of said screw guiding block is provided with a screw thread for engaging and positioning of a thread of said screw rod.

5. A quick clamping vice structure for a circular saw as in claim 1, wherein, said seat member is provided on the top thereof with a screw hole in communication with said through hole, a screw is engaged in said screw hole by means of screw threads and extends into an annular engaging groove of said shifting rod inserted into said through hole, thereby, said shifting rod only rotates rather than slide leftwards or rightwards.

6. A quick clamping vice structure for a circular saw as in claim 1 or 5, wherein, said shifting rod is connected to a grip in favor of rotation of said shifting rod.

7. A quick clamping vice structure for a circular saw as in claim 1, wherein, said shifting rod is provided with a bending portion, and is movably and pivotally provided on an engaging axle in said through hole of said seat member, said shifting rod is provided on the front end thereof with a protruding engaging block and on the other end thereof with a pressing portion in favor of raising of said screw guiding block.

8. A quick clamping vice structure for a circular saw as in claim 1, wherein, said vice seat is provided on the rear side thereof with an upper plate portion and a lower plate portion both extending transversely, said upper and said lower plate portions are provided each with a hole for extending therethrough said fixing screw.

9. A quick clamping vice structure for a circular saw as in claim 8, wherein, said fixing screw is provided on the top thereof with a bolt head, and on the bottom thereof with a threaded protrusion, a through hole is provided on the shank of said fixing screw to be connected with said screw rod.

10. A quick clamping vice structure for a circular saw as in claim 1, wherein, said base is provided with a slit to allow a threaded protrusion on the bottom of said fixing screw to slide therein, said vice seat thus is moved steadily.
